(19) United States
(12) Patent Application Publication
(10) Pub. No.: US 2008/0266844 A1
(43) Pub. Date: Oct. 30, 2008

(54) Toilet paper holder task light device

(76) Inventors: Daniel A. Reynolds, Boca Raton, FL (US); Barton F. Reynolds, Margate, FL (US)

Correspondence Address: DANIEL A. REYNOLDS AND BARTON F. REYNOLDS;c/o G & E ENTERPRISES, INC., 3350 SW 15 STREET, DEERFIELD BEACH, FL, 33442, US

(21) Appl. No.: 11/789,070

(22) Filed: Apr. 24, 2007

(51) Int. Cl. F21S 8/00

(52) U.S. Cl. 362/147

(57) ABSTRACT

A toilet paper holder task light device that emanates a gentle, soft glow and task lighting to assist a user with the use of the toilet paper holder and toilet paper in the absence of sufficient natural lighting creating a soothing atmosphere conducive to bodily functions and without re-dilating one's eyes during nighttime use. The device is a removable wall attachment above the toilet paper holder that, when activated, illuminates the semi-translucent case of the device by means of a high-intensity, blue LED creating a glow and surrounding luminosity. The light is directed downward and outward at a pre-engineered angle to illuminate the toilet paper holder and toilet paper for the user's task management and reloading, as needed, accommodating both male and female users of all ages. A timer circuit which, when energized, activates the LED and switching device (manual or automated), i.e., darkness sensor and proximity switch activated by the user's hand in the general vicinity of the existing toilet paper holder. At the end of a fixed or adjusted time interval, the device shuts off and remains in a default mode until reactivated by the user.

### BACKGROUND OF THE INVENTION

1. Field of the Invention

Present invention is directed to be used as a toilet paper task light device that creates a soothing glow and sufficient lighting to assist the user of the toilet paper holder and toilet paper in the absence of sufficient lighting caused by insufficient natural lighting, nighttime, power failure, or in interior bathroom placement, i.e., condominium buildings, townhouse buildings, apartment complexes, or commercial facilities, but not limited to, so when activated creates a relaxing glow conducive to bodily functions in conjunction with creating sufficient task lighting to assist the user of the toilet paper holder and toilet paper for the task at hand or in reloading.

2. Background of the Invention

The present invention relates to the use of the self-contained light source that when triggered by the user creates a soothing glow conducive to bodily functions and sufficient task lighting for the use of the toilet paper holder and toilet paper at night or during the absence of natural lighting or power failure.

### OBJECTIVES OF THE INVENTION

An objective of the present invention is to provide a toilet paper holder device that creates a glow that is conducive to bodily functions in conjunction with creating task lighting for the use of an existing toilet paper holder and the toilet paper by the user in the absence of sufficient lighting.

It is a further objective of the present invention to create a device that when activated emanates a soothing glow that is conducive to bodily functions for male and female users of all ages.

It is still a further objective of the present invention to create a device that when activated illuminates a toilet paper holder and toilet paper as to assist the user.

It is still a further objective of the present invention to create a device that is more conducive to working in the absence of sufficient lighting and/or nighttime conditions that creates a less harsh environment than would normally be created by standard lighting.

It is still a further objective of the present invention to create a device that would work well and universally with the conditions of existing toilet paper holders having no retrofit requirements, thereby creating a device that is universally compatible with existing conditions.

It is still a further objective of the present invention to create a device that would assist the user in reloading of the toilet paper holder in the absence of sufficient lighting.

It is still a further objective of the present invention to create a device that helps minimize unnecessary toilet paper consumption and waste by all users in times of insufficient lighting.

It is still a further objective of the present invention to create a device that, by means of incorporating well-known timer circuit configurations in conjunction with well-known manual or automated switching configurations, when activated by the user allows the device to cycle thereby creating an auto off function. This, in return, allows the user to trigger the device upon task completion and use the glow illumination portion of the device to exit the area safely. This can be extremely helpful for either very young or elderly users.

It is still a further objective of the present invention that the glow and task lighting created by the device for use of the toilet paper holder and toilet paper also created an environment that could benefit enlarged prostrate sufferers with some of the frequent problems associated with this condition. The glow from the device creates a less harsh environment during nighttime use that is more conducive and relaxing to the user. The task lighting that the device provides assists in helping the user cleanup with toilet paper from the toilet paper holder. The need for this additional cleanup is created from the condition where the urinary stream and control of the stream are impeded.

### SUMMARY OF THE INVENTION

In keeping with these objectives and others which may become apparent, this invention relates to a toilet paper holder task light device which creates no impact or disruption of the conditions of the existing toilet paper holder by means of attaching to the wall above the existing toilet paper holder.

To that end, the present invention includes a housing with a semi-translucent front. The device positions a high-intensity, blue LED at a pre-engineered angle that creates the glow of the device and surrounding luminosity in conjunction with directing light downward and outward over the existing toilet paper holder and toilet paper. This creates a soothing glow of the device and surrounding area in conjunction with casting sufficient task lighting for the use and reloading of the existing toilet paper holder by male and female users of all ages during insufficient lighting conditions.

The device incorporates a well-known timer circuit with well-known manual and/or automated switches, i.e., darkness sensor and proximity indicator, that when triggered by the user energizes the high-intensity, blue LED lamp creating the device's glow and task light use. At the end of the time circuit interval, the device auto shuts off and remains in a default mode until reactivated by the user.

### BRIEF DESCRIPTION OF THE DRAWINGS

For further understanding of the nature of the present invention, record should be made to the following detailed descriptions taken in conjunction with the accompanying drawings in which:

FIG. 1 is a front, top, semi-translucent perspective view of the toilet paper holder task light device of the present invention;

FIG. 2 is a side elevation view of the device;

FIG. 3 is a front perspective view showing the device installed on the wall directly above the existing toilet paper holder where the device's glow and task lighting is directed downward and outward onto the existing toilet paper holder, toilet paper, and surrounding area.

FIG. 4 is a plan view showing the component in a housing of the device; and

FIG. 5 is an electric schematic of the device components. Like referenced numerals refer to parts throughout the several views of the drawings.

### DETAILED DESCRIPTIONS OF THE PREFERRED EMBODIMENT

Referring to the several views of the drawings, the toilet paper holder task light device of the present invention is shown and generally indicated as (10). The toilet paper holder task light device (10) is intended for removable attachment to the wall (100) directly above the existing toilet paper holder (110) so that the glow (46) from the device illuminates the device and surrounding area in conjunction with directing light downward and outward over the existing toilet paper holder (110).

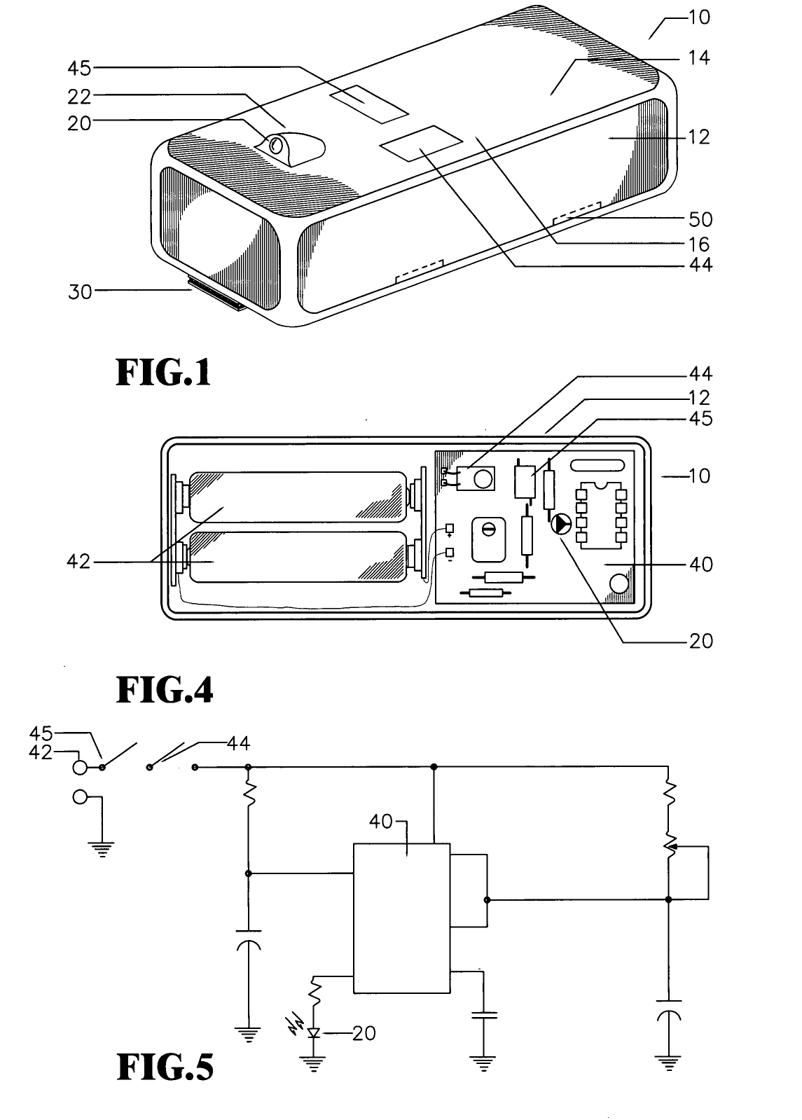

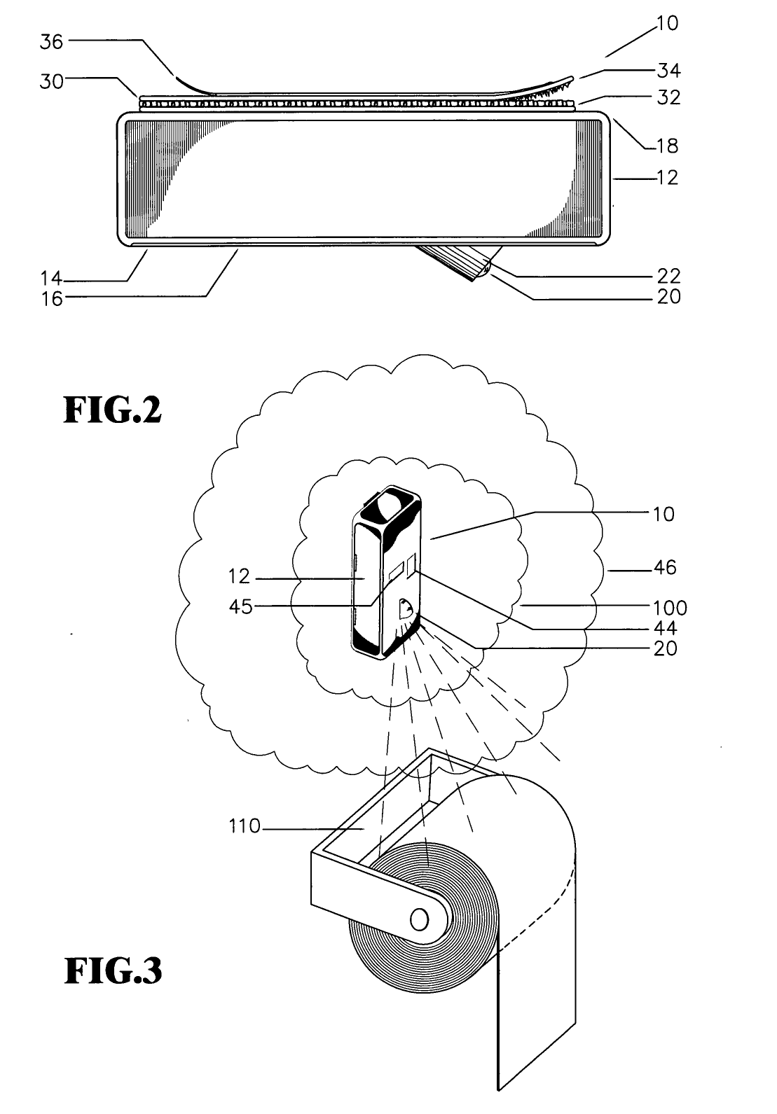

As seen in FIGS. 1-3, the toilet paper holder task light device (10) includes an outer housing (12) including a semi-translucent front face (16) and a rear face (18). In a preferred embodiment, the housing includes a cover (14) which includes the semi-translucent front face (16) and surrounding sidewalls. The housing (12) is preferably formed of plastic composition which can be conventionally molded in a high volume manufacturing operation. A light emitting source (20) is positioned and disposed on the semi-translucent front face (16) of housing (12) at a pre-engineered angle which creates the device's glow (46) in conjunction with directing task lighting downward and outward from the light emitting source (20) when the device (10) is attached to the wall (100) directly above the existing toilet paper holder (10).

In a preferred embodiment, a semi-translucent shielded area (22) is formed on the semi-translucent front face (16) of the housing (12) to support and position the light-emitting source (20) as to create the device's glow (46) and the proper pre-engineered angle for the task lighting from the light-emitting source (20) downward and outward over the toilet paper holder (110).

In a preferred embodiment, the light-emitting source is a high-intensity, blue LED lamp. However, other suitable light emitting devices of well-known types are contemplated and intended to be within the spirit and scope of the invention.

As stated above, the device (10) is a removable attachment to the wall (100). To achieve this removable attachment, the present invention proposes the use of a hook and loop fastening system. Specifically, a hook component (32) is adhered to the rear face (18) of the housing (12) for mating removable attachment to a loop component (34) attached to the wall (100). Upon initial installation, a protective film (36) is removed from the rear side of the loop component (34) to expose an adhesive material. This permits attachment of the loop component (34) to the wall surface (100) in the well-known manner. Alternatively, a double-sided tape may be provided on the rear face of the housing to permit removable attachment of the device (10) to the wall (100). Other suitable and well-known means of removable attachment are contemplated and intended to be within the spirit and scope of the invention.

Referring to FIGS. 4 and 5, a circuit of the device (10) is shown and indicates an integrated timer circuit (40), a battery power source (42), an on/off switch or a darkness sensor (45) and a proximity switch (44) and the high-intensity, blue LED lamp (20). In a preferred embodiment, the integrated timer circuit is, or similar to, a 555 integrated timer. The on/off switch or the darkness sensor (45) and a proximity switch (44) is said to be triggered manually or, in the case of the proximity switch, by the person's hand in the proximity of the existing toilet paper holder (110) as seen in FIG. 3. When the darkness sensor (45) and proximity switch (44) is triggered, this causes the integrated timer circuit (40) to be energized for a fixed period of time. The period of time may be fixed or adjusted by the manufacturer. In normal use, the integrated timer circuit should be energized for at least one minute and preferably no longer than five minutes to conserve on battery power. When the timer circuit (40) is energized, electric current flow is completed to the high-intensity, blue LED lamp (20) causing the LED lamp (20) to be illuminated. The LED lamp (20) remains illuminated throughout the time during which the integrated timer circuit (40) is energized.

This allows a person the proper task lighting necessary. At the expiration of the period of energized time of the integrated timer circuit (40), either fixed or adjusted, the LED lamp (20) is deactivated. The integrated timer circuit (40) remains in a default mode until subsequently being reactivated by the user triggering the darkness sensor (45) and the proximity trigger switch (44).

However, other suitable timer circuits and automated switching devices of well-known types are contemplated and intended to be within the spirit and scope of the invention as it may refer to cost for efficient manufacturing.

In another preferred embodiment, as seen in FIG. 1, a mechanical snap (50) integral to plastic moldings may be provided for the cover (14) of the housing (12) in order to access the internal components circuit, and/or the batteries (42) when there is a need for battery replacement.

What is claimed is:

1. A universal toilet paper holder task light device which when mounted above an existing toilet paper holder and triggered by the user creates a task light and glow that increases one's ability to perform the task necessary in the absence of sufficient light.

2. A device as recited in claim 1 further comprising;
a housing including a front face and rear face;
a timer circuit adapted for connection to any electrical power source and including:
a blue LED light-emitting source;
a manual or automated trigger activated switch adapted for connection to timer circuit;
a removable attachment to the wall just above the existing toilet paper holder.
Said light-emitting source has been positioned on said front face of said housing so being structured as to create a glow in the vicinity of the device and to direct light downward and outward at a pre-engineered angle creating task lighting for the use of the existing toilet paper holder in conjunction with minimizing the dilation of one's eyes during insufficient natural lighting caused by nighttime, interior bathroom placement, i.e., condominium buildings, townhouse buildings, apartment complexes and commercial facilities, and main power failure.

3. The device as recited in claim 2 wherein said means for removable attachment of the device to the wall above the existing toilet paper holder includes hook and loop fasteners.

4. The device as recited in claim 2 wherein said light-emitting source that creates both the glow and the task light is a high intensity, blue LED light-emitting source being structured and disposed at a pre-engineered angle to direct light downward and outward.

5. The device as recited in claim 2 where the said housing includes a front face, this front face is to be created in such a fashion and of a semi-translucent material as to create a glow of the device and the proper task lighting positioning directed downward and outward when activated during periods of insufficient natural lighting.

6. The device as recited in claim 1 wherein said device is to be attached to the wall directly above the existing toilet paper holder has been developed as to work universally with all types of existing toilet paper holders.

7. The device as recited in claim 2 further comprising;
the integrated timer circuit which when triggered by either manual or automated series of switches, i.e., darkness sensor, proximity switch, illuminates the high-intensity, blue LED light-emitting source for a predetermined time.

8. The device as recited in claim 7 integrated timer circuit with trigger switch creates an auto off condition which creates an environment for conservation of the power source.

9. The device as recited in claim 7 integrated timer circuit with trigger switch that by creating an auto off condition allows for the device, after being triggered and operating for the predetermined time, to shut off automatically and lie dormant until the device is triggered again repeating the cycle.

10. The device as recited in claim 8 that creates an auto off condition also allows the operator to trigger the device upon the completion of using the toilet paper holder which will allow the glow from the device to create and illuminate the area for safe exiting under insufficient lighting.

11. The toilet paper holder task light device was developed with its task lighting directed downward and outward and the device's glow in conjunction with the ability of male and female users using the toilet paper holder efficiently during insufficient lighting.
It was also developed to help male users suffering from an enlarged and/or over active prostate condition who find themselves frequently needing to urinate at night. The task light portion of the device can assist this type of user with the necessary cleanup that is required due to this condition caused by inconsistent stream and/or control of stream creating the direct need for task lighting of the toilet paper holder. The glow of the device also helps in creating a conducive, low light environment which can assist users that suffer from this problem in relaxing.

12. The device as recited in claim 11 where said toilet paper holder task light device creates sufficient illumination to assist in creating an atmosphere conducive, due to its glow, as to relax the user by means of not fully re-dilating their eyes during frequent nighttime use.

13. The device as recited in claim 11 where said toilet paper holder task light device creates sufficient illumination to assist a male user suffering with a prostate condition the ability to clean up the area with the toilet paper after urination. This condition can create an inconsistent stream and/or control of stream creating a need for above normal cleanup needs of the area using the toilet paper in conjunction with the toilet paper task light.

14. The device as recited in claim 11 where said toilet paper holder task light device assists in a conducive and task oriented illumination of the environment to assist nighttime sufferers.
